(19) United States
(12) Patent Application Publication
(10) Pub. No.: US 2018/0354171 A1
(43) Pub. Date: Dec. 13, 2018

(54) PRODUCTION METHOD FOR COVER

(71) Applicant: JTEKT CORPORATION, Osaka-shi, Osaka (JP)

(72) Inventors: Yoichiro SANKAI, Kashiwara-shi (JP); Teruyuki WAKISAKA, Nagoya-shi (JP); Akihiro TAKEUCHI, Kashiba-shi (JP)

(73) Assignee: JTEKT CORPORATION, Osaka-shi, Osaka (JP)

(21) Appl. No.: 15/775,711

(22) PCT Filed: Nov. 10, 2016
(86) PCT No.: PCT/JP2016/083314

§ 371 Date: May 11, 2018

(30) Foreign Application Priority Data
Nov. 13, 2015 (JP) 2015-223007

(51) Int. Cl. B29C 45/14; B29C 45/26; B29C 33/12; F16C 33/76

(52) U.S. Cl. CPC B29C 45/14065; B29C 45/26; B29L 2031/32; F16C 33/76; B29C 2045/14122; B29C 33/12

(57) ABSTRACT

A production method for a cover attached to an outer ring of a hub unit including procedures as follows. A nut is supported by a first protrusion of a first mold. By a second protrusion of a second mold, a core bar including a cylindrical section to be inserted into the outer ring is supported. A resin material is injected into a cavity formed by the first mold and the second mold to form a cover including a nut and a core bar. The cover is detached from the second mold by moving the first mold in a direction of being separated from the second mold. After this, the cover is detached from the first mold by pushing out the cover in a die matching direction with a pin disposed in the first mold.

### TECHNICAL FIELD

One aspect of the present invention relates to a production method for a cover attached to a hub unit.

### BACKGROUND ART

A hub unit is used to rotatably attach wheels of a vehicle to a suspension. In addition, in a vehicle having an anti-lock braking system, a sensor for detecting the rotational speed of the wheel is attached to the hub unit.

JP-A-2013-155881 discloses a sensor cap for attaching the above-described sensor to a hub unit. The sensor cap includes a cap main body and a core metal. The cap main body is formed by injection molding a synthetic resin. The core bar is molded in an opening portion of the cap main body. The cap main body is formed with an attachment portion which protrudes in an axial direction. An insertion hole which extends in the axial direction is formed in the attachment portion. A sensor unit is mounted in the insertion hole. A nut is embedded in the attachment portion. The sensor unit is fixed to the attachment portion via a fixing bolt attached to the nut.

The core bar of the sensor cap described in JP-A-2013-155881 has a cylindrical section and a flange. The cylindrical section is inserted into an outer ring of the hub unit when the sensor cap is attached to the hub unit. The flange is formed at one axial end of the cylindrical section. The flange extends outward in a radial direction of the cylindrical section. The cap main body included in the sensor cap described in JP-A-2013-155881 includes a covering portion which covers a flange of the core bar. The covering portion is in contact with the axial end surface of the outer ring in a state where the sensor cap is attached to the hub unit. Accordingly, the sealing property between the sensor cap and the outer ring is ensured.

### PRIOR ART DOCUMENT(S)

### Patent Document(s)

Patent Document 1: JP-A-2013-155881

### SUMMARY OF THE INVENTION

### Problem to be Solved by the Invention

The sensor cap described in JP-A-2013-155881 is produced by injecting a resin material into a molding die in a state where a nut and a core bar are disposed at predetermined positions in the molding die. For example, a molding die is formed with a stationary die having a protrusion for supporting a nut formed thereon and a movable die having a protrusion for supporting a core bar formed thereon. In a state where the nut is supported by the stationary die and the core bar is supported by the movable die, die matching is performed with respect to the stationary die and the movable die. Accordingly, the nut and the core bar are disposed at predetermined positions in the molding die. In this state, the sensor cap is produced by injecting a resin material into the molding die from a nozzle assembled to the stationary die.

When detaching the sensor cap from the molding die, for example, the following method can be considered. First, the sensor cap is detached from the stationary die by moving the movable die in a direction of being separated from the stationary die. Thereafter, the sensor cap is detached from the movable die by a plurality of pins provided in the movable die.

The plurality of pins are pressed against an annular surface formed in the covering portion which covers the flange of the core bar of the sensor cap. The annular surface comes into contact with the axial end surface of the outer ring in a state where the sensor cap is attached to the hub unit.

As described above, when the plurality of pins are pressed against the annular surface, a recess is formed on the annular surface due to the pins pressed against thereto. When the sensor cap is attached to the outer ring in a state where foreign substances entered the recess, there is a concern that sealing properties between the axial end surface of the outer ring and the annular surface of the sensor cap deteriorate.

An object of one aspect of the present invention is to provide a production method for a cover that can ensure sealing properties in a state of being attached to an outer ring of a hub unit.

### Means for Solving the Invention

According to an embodiment of the present invention, there is provided a production method for a cover to be attached to an outer ring of a hub unit, including: preparing a first mold having a first protrusion which protrudes into a first recess portion that forms a part of a cavity to be filled with a resin material; preparing a second mold having a second protrusion which protrudes into a second recess portion that forms another part of the cavity; supporting a nut by the first protrusion; supporting a core bar including a cylindrical section to be inserted into the outer ring by the second protrusion; forming the cavity by performing die matching with respect to the first mold and the second mold; forming the cover including the nut and the core bar by injecting a resin material into the cavity; detaching the cover from the second mold by moving the first mold in a direction away from the second mold; and detaching the cover from the first mold by pushing out the cover in a die matching direction with a pin disposed in the first mold after detaching the cover from the second mold.

### ADVANTAGE OF THE INVENTION

The cover produced by the production method according to the embodiment of the present invention can ensure the sealing properties in a state of being attached to the outer ring of the hub unit.

### BRIEF DESCRIPTION OF THE DRAWINGS

FIG. 1 is a sectional view illustrating a hub unit to which a cover produced by a production method for a cover according to an embodiment of the invention is attached.

FIG. 2 is a sectional view of the cover.

FIG. 3 is an enlarged sectional view illustrating the cover attached to the outer ring of the hub unit.

FIG. 4A is a sectional view illustrating the production method for a cover, and is the sectional view illustrating a state where a nut and a core bar are disposed in a molding cavity formed in a mold.

FIG. 4B is a sectional view illustrating the production method for a cover, and is the sectional view illustrating a state where a resin material is injected into the mold.

FIG. 4C is a sectional view illustrating the production method for a cover, and is the sectional view illustrating a state where the cover is detached from the mold which supports the core bar.

FIG. 5 is an enlarged sectional view illustrating a part of FIG. 4A.

FIG. 6 is a sectional view illustrating a state where the resin material is injected toward the nut.

### MODE FOR CARRYING OUT THE INVENTION

A production method for a cover according to an embodiment of the present invention is a production method for a cover attached to an outer ring of the hub unit. The production method includes the following steps (A) to (H). In step (A), a first mold having a first protrusion which protrudes into a first recess portion that forms a part of a cavity filled with a resin material is prepared. In step (B), a second mold having a second protrusion which protrudes into a second recess portion that forms another part of the cavity is prepared. In step (C), a nut is supported by the first protrusion. In step (D), by a second protrusion, a core bar including a cylindrical section to be inserted into the outer ring is supported. In step (E), the first mold and the second mold are die-matched to form the cavity. In step (F), a resin material is injected into the cavity to form a cover including a nut and a core bar. In step (G), the cover is removed from the second mold by moving the first mold in a direction of being separated from the second mold. In step (H), after the cover is detached from the second mold, the cover is detached from the first mold by pushing out the cover in the die matching direction with a pin disposed in the first mold.

The second mold used in the production method supports the core bar including the cylindrical section to be inserted into the outer ring of the hub unit. Therefore, a part of a surface of the cover produced by the above-described production method, which comes into contact with the second mold, includes a part which comes into contact with the outer ring of the hub unit, but a part which comes into contact with the first mold does not include a part which comes into contact with the outer ring of the hub unit.

In the above-described production method, after detaching the cover from the second mold, the cover is pushed out with the pin disposed in the first mold. In other words, a part against which the pin is pressed is a part which does not come into contact with the outer ring on the surface of the cover. Therefore, there is no case where a recess formed by pressing the pin is formed at the part which comes into contact with the outer ring on the surface of the cover. As a result, it is possible to prevent foreign substances which have entered the recess from being caught between the cover and the outer ring. Therefore, it is possible to ensure sealing properties between the cover and the outer ring.

Preferably, the core bar further includes a flange. The flange is formed at one axial end of the cylindrical section and extends outward in the radial direction of the cylindrical section from one axial end of the cylindrical section. The cover preferably includes a covering portion which covers the flange. Preferably, in the step of detaching the cover from the first mold, the cover is detached from the first mold by pushing the covering part with a pin.

In the above-described aspect, an outer circumferential part of the cover (specifically, a part which is positioned on the outside in the radial direction from the cylindrical section of the core bar) is pushed by the pin. Therefore, when the cover is detached from the first mold, the cover is unlikely to be deformed.

Preferably, in the step of detaching the cover from the first mold, a position that overlaps the flange when viewed from the die matching direction of the covering portion is pressed with the pin. In this case, since a force of pushing with the pin acts on the flange, the cover is unlikely to be deformed when the cover is detached from the first mold.

Preferably, a plurality of pins are disposed in the first mold. In this case, a plurality of locations of the cover are pushed by the pins. Therefore, it becomes easy to detach the cover from the first mold.

Preferably, the plurality of pins are disposed at equivalent intervals spaced in a circumferential direction of the cylindrical section. In this case, it is possible to eliminate unbalance of force when pushing a plurality of locations of the cover with pins. Therefore, when the cover is detached from the first mold, the cover is unlikely to be deformed.

Hereinafter, embodiments of the present invention will be described with reference to the drawings. The same or corresponding parts in the drawings will be given the same reference numerals, and the description thereof will not be repeated.

### EMBODIMENT

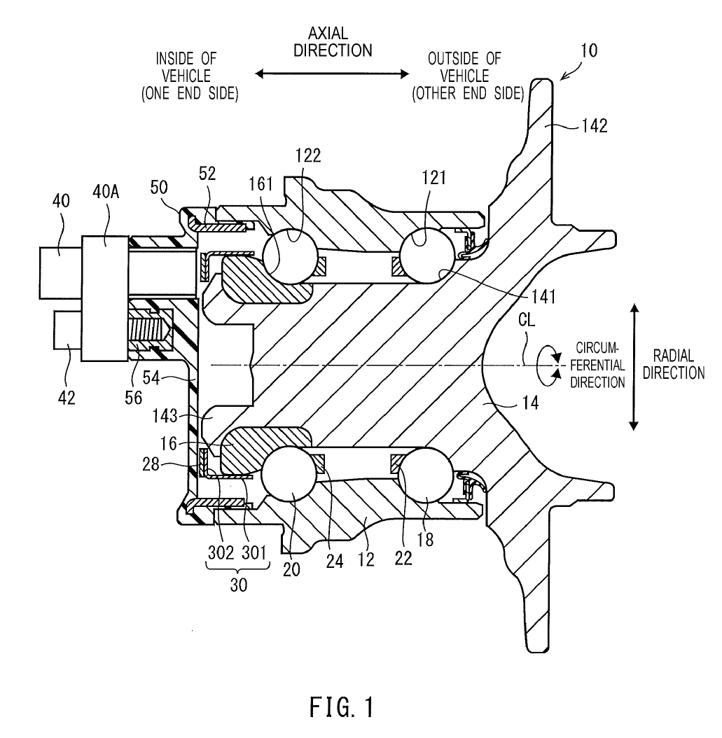

FIG. 1 illustrates a hub unit 10 to which the cover produced by the production method according to an embodiment of the present invention is attached. In addition, in the following description, an axial direction is a direction in which the center shaft line CL of the hub unit 10 extends. The radial direction is a direction perpendicular to the center shaft line CL, that is, a direction perpendicular to the axial direction. The circumferential direction is a direction around the center shaft line CL. In a state where the hub unit 10 is disposed in a vehicle, one axial end side (left end side in FIG. 1) of the hub unit 10 corresponds to the inside of the vehicle, and the other axial end side of the hub unit 10 (right end side in FIG. 1) corresponds to the outside of the vehicle.

1. Hub Unit

With reference to FIG. 1, the hub unit 10 includes an outer ring 12, an inner shaft 14, an inner ring 16, a plurality of rolling elements 18, a plurality of rolling elements 20, a retainer 22, and a retainer 24. Hereinafter, the members will be described.

The outer ring 12 has a cylindrical shape. On the inner circumferential surface of the outer ring 12, two raceway surfaces 121 and 122 are formed. The outer ring 12 is, for example, fixed to a suspension.

The inner shaft 14 is disposed on the inside of the outer ring 12 and positioned coaxially to the outer ring 12. The inner shaft 14 is disposed so as to be rotatable in the circumferential direction with respect to the outer ring 12.

The inner shaft 14 has a raceway surface 141. The raceway surface 141 is formed on the outer circumferential surface of the inner shaft 14.

The inner shaft 14 further includes a flange 142. The flange 142 is formed continuously in the circumferential direction.

A plurality of holes are formed in the flange 142. The plurality of holes are positioned at equivalent intervals in the circumferential direction, for example. Wheels, brake discs, and the like are attached to the inner shaft 14 by bolts inserted into each of the plurality of holes.

The inner wheel 16 has a cylindrical shape. The inner ring 16 is fixed to the inner shaft 14. Specifically, in a state where the inner shaft 14 is press-fitted to the inner ring 16, the inner ring 16 is caulked and fixed to the inner shaft 14 by a caulking portion 143 formed at a left end (one axial end) of the inner shaft 14.

The inner ring 16 includes a raceway surface 161. The raceway surface 161 is formed on the outer circumferential surface of the inner wheel 16.

The plurality of rolling elements 18 are disposed between the outer ring 12 and the inner shaft 14. The plurality of rolling elements 18 are disposed at equivalent intervals in the circumferential direction by the retainer 22. Each of the plurality of rolling elements 18 comes into contact with the raceway surface 121 and the raceway surface 141.

The plurality of rolling elements 20 are disposed between the outer ring 12 and the inner ring 16. The plurality of rolling elements 20 are disposed at equivalent intervals in the circumferential direction by the retainer 24. Each of the plurality of rolling elements 20 comes into contact with the raceway surface 122 and the raceway surface 161.

2. Pulser Ring

In the hub unit 10, a pulser ring 28 is fixed to the inner ring 16 via the core bar 30.

The core bar 30 includes a cylindrical portion 301 and an annular plate portion 302. The cylindrical portion 301 has a cylindrical shape. At the left end (one axial end) of the cylindrical portion 301, an annular plate portion 302 is disposed. The annular plate portion 302 has an annular plate shape. An outer circumferential edge of the annular plate portion 302 is formed integrally with the left end (one axial end) of the cylindrical portion 301.

The pulser ring 28 is fixed to one surface in the thickness direction of the annular plate portion 302 (the end surface on the left side in FIG. 1). As a method of fixing the pulser ring 28 to the annular plate 302, for example, there is a case where adhesion is performed. In the pulser ring 28, N poles and S poles are alternately magnetized in the circumferential direction.

3. Cover

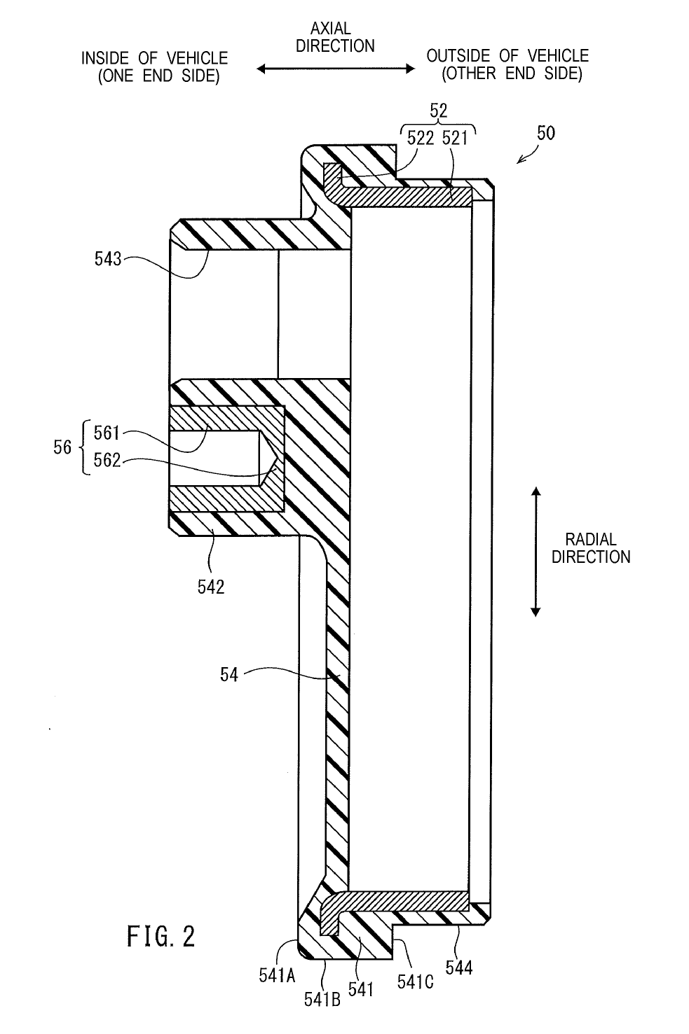

A cover 50 is fixed to the hub unit 10. The cover 50 will be described with reference to FIG. 2. The cover 50 includes a core bar 52, a cover main body 54, and a nut 56.

The core bar 52 is formed of a metal. The core bar 52 includes a cylindrical portion 521 and a flange portion 522. The cylindrical portion 521 has a cylindrical shape. At the left end (one axial end) of the cylindrical section 521, a flange portion 522 is disposed. The flange portion 522 has an annular plate shape. The inner circumferential edge of the flange portion 522 is formed integrally with the left end (one axial end) of the cylindrical section 521.

The cover main body 54 is disposed at the left end (one axial end) of the cylindrical section 521. The cover main body 54 is formed of a synthetic resin. The cover main body 54 has a disc shape. The outer circumferential edge of the cover main body 54 is connected to the left end (one axial end) of the cylindrical section 521 across the entire circumference. In other words, the cover main body 54 covers the opening at the left end (one axial end) of the cylindrical section 521.

The cover main body 54 includes a covering portion 541. The covering portion 541 is positioned at the outer circumferential edge of the cover main body 54. The covering portion 541 is formed across the entire circumference. In other words, the covering portion 541 has a cylindrical shape. The covering portion 541 covers both surfaces (left and right end surfaces in FIG. 2) in a thickness direction of the flange portion 522 across the entire circumference. In other words, the flange portion 522 is buried in the covering portion 541. The covering portion 541 covers the outer circumferential surface of the cylindrical section 521 across the entire circumference.

The covering portion 541 has an end surface 541A, an outer circumferential surface 541B, and an end surface 541C. Hereinafter, the members will be described.

The end surface 541A regulates the left end (one axial end) of the covering portion 541. The end surface 541A has an annular shape. The end surface 541A is positioned at the outer circumferential edge portion of the end surface of the cover main body 54 in the thickness direction (leftward-and-rightward direction in FIG. 2, that is, axial direction).

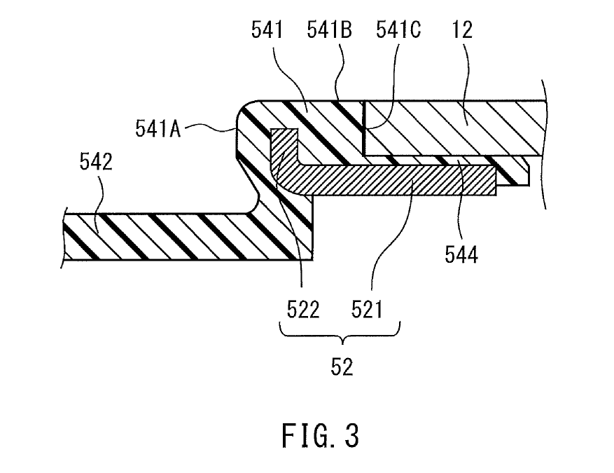

The end surface 541C regulates the right end (the other axial end) of the covering portion 541. The end surface 541C has an annular shape. As illustrated in FIG. 3, in a state where the cover 50 is attached to the outer ring 12, the end surface 541C comes into contact with the axial end surface of the outer ring 12. Accordingly, sealing properties between the cover 50 and the outer ring 12 are ensured.

The outer circumferential surface 541B has a cylindrical shape. The outer circumferential surface 541B extends straight in the axial direction with a constant diameter. The left end (one end in the axial direction) of the outer circumferential surface 541B is connected to the outer circumferential edge of the end surface 541A. The right end (the other end in the axial direction) of the outer circumferential surface 541B is connected to the outer circumferential edge of the end surface 541C.

The cover main body 54 includes a covering layer 544. The covering layer 544 extends in the axial direction from the end surface 541C of the covering portion 541. The covering layer 544 covers the outer circumferential surface of the cylindrical section 521 of the core bar 52 across the entire circumference.

As illustrated in FIG. 3, in a state where the cover 50 is attached to the outer ring 12, the covering layer 544 is positioned between the cylindrical section 521 of the core bar 52 and the outer ring 12. Accordingly, sealing properties between the cover 50 and the outer ring 12 are ensured.

As illustrated in FIG. 2, the cover main body 54 includes an attachment portion 542. The attachment portion 542 protrudes from the cover main body 54 toward the left side (one axial end side). The attachment portion 542 extends in the axial direction with a substantially constant sectional shape.

In the cover main body 54, an insertion hole 543 is formed at a position at which the attachment portion 542 is formed. The insertion hole 543 extends in the axial direction and has a cylindrical inner circumferential surface. The insertion hole 543 is formed to penetrate the cover main body 54 in the axial direction.

In the attachment portion 542, the nut 56 is embedded at a position different from the position at which the insertion hole 543 is formed. The nut 56 includes a cylindrical section 561 and a stopper 562.

The cylindrical section 561 has a cylindrical shape. A screw groove is formed on the inner circumferential surface of the cylindrical section 561. In a state where the nut 56 is embedded in the attachment portion 542, the left end surface (one axial end surface) of the cylindrical section 561 is exposed. In other words, in a state where the nut 56 is embedded in the attachment portion 542, the left end surface (one axial end surface) of the cylindrical section 561 is not covered with the attachment portion 542.

The stopper 562 is formed at the right end (the other axial end) of the cylindrical section 561. The stopper 562 has a disc shape and regulates the right end (an end on the other axial end side) of the hole of the cylindrical section 561.

4. Production Method for Cover

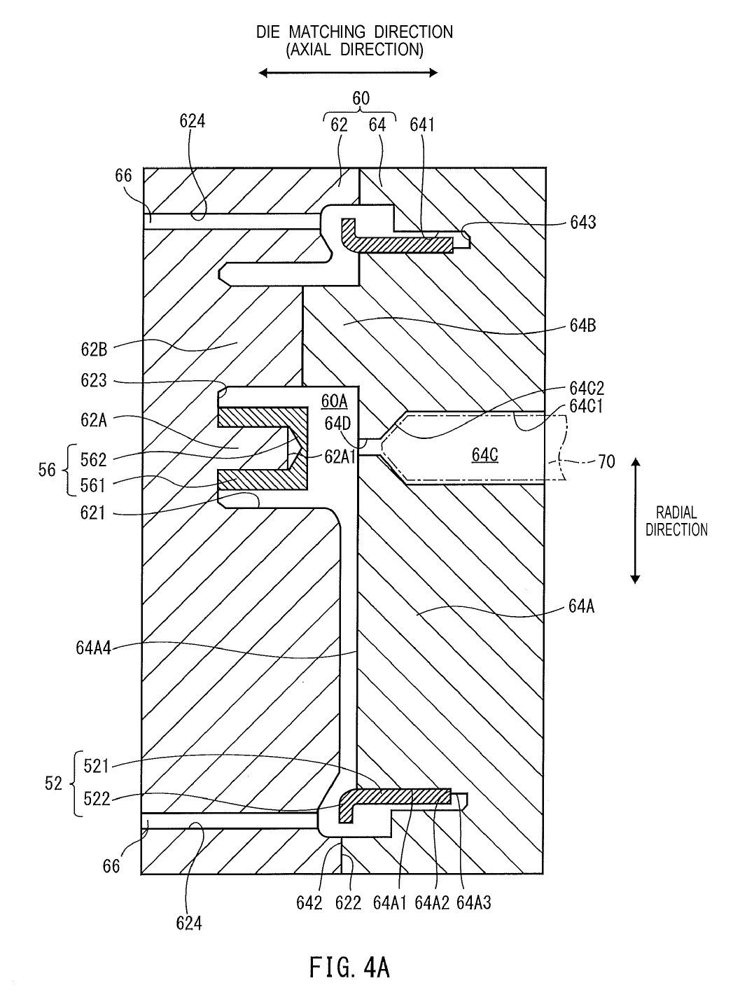

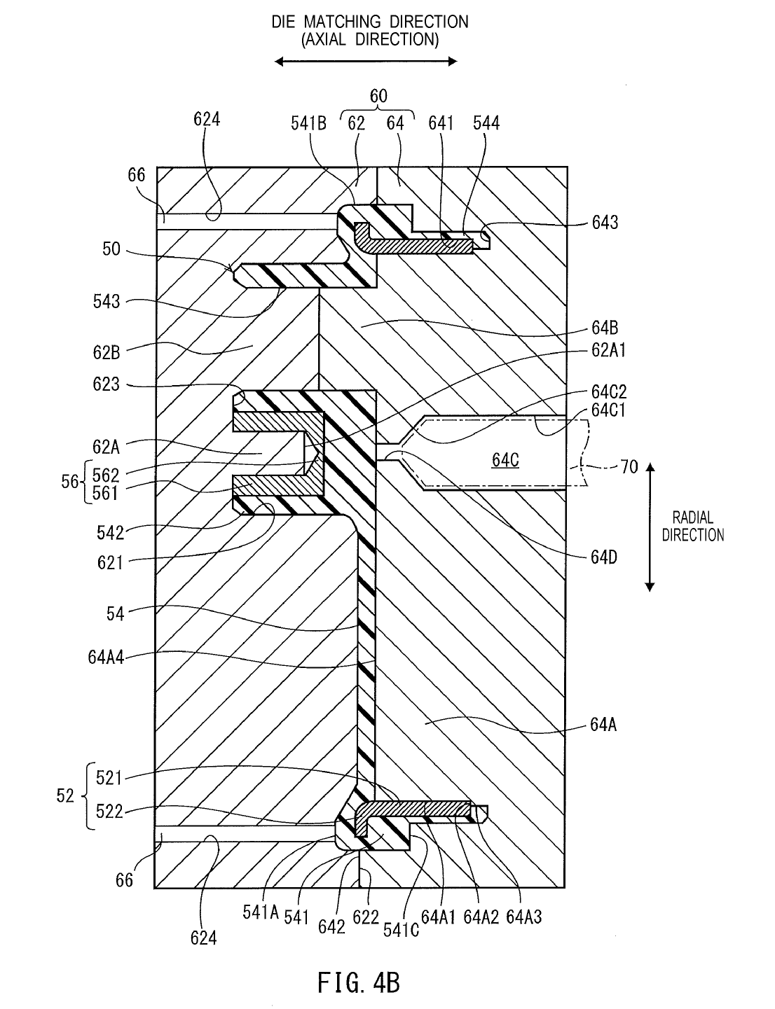

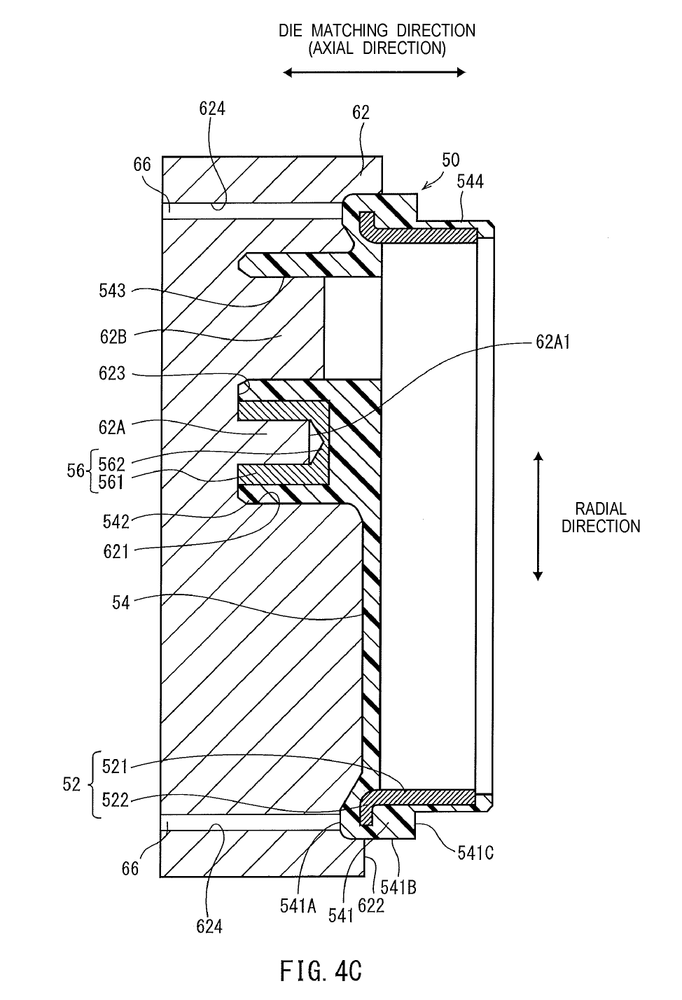

Next, a production method for the cover 50 will be described. First, a mold 60 (refer to FIG. 4A) used for producing the cover 50 is prepared. Next, as illustrated in FIG. 4A, the core bar 52 and the nut 56 are disposed in the metal mold 60.

The mold 60 includes a mold 62 that serves as a first mold and a mold 64 that serves as a second mold. By die-matching the mold 62 and the mold 64, a cavity 60A is formed in the mold 60.

Hereinafter, details of the mold 62 and the mold 64 will be described. In addition, in the following description, the leftward-and-rightward direction in the drawing is a die matching direction of the mold 62 and the mold 64.

A recess portion 621 that serves as a first recess portion is formed in the mold 62. The recess portion 621 is open on a die matching surface 622 with the mold 64 in the mold 62. In other words, the recess portion 621 is open toward the mold 64. In short, the recess portion 621 is open in the die matching direction.

In the recess portion 621, an end surface 623 is formed. The end surface 623 is at a position separated the most from the die matching surface 622. The end surface 623 regulates the end of the recess portion 621 in the die matching direction. The end surface 623 has a shape that corresponds to a tip end surface of the attachment portion 542 of the cover 50.

In the recess portion 621, a protrusion 62A and a protrusion 62B are disposed. The protrusion 62A protrudes from the end surface 623 toward the mold 64. In short, the protrusion 62A protrudes in the die matching direction from the end surface 623. The protrusion 62A has a cylindrical shape. In other words, the protrusion 62A extends in the die matching direction with a substantially constant diameter. The protrusion 62A has a rounded tip end surface 62A1.

The protrusion 62A is inserted into the cylindrical section 561 of the nut 56. In the state, the tip end surface of the protrusion 62A is in contact with the stopper 562 of the nut 56.

The protrusion 62B is formed at a position different from the protrusion 62A. The protrusion 62B protrudes from the end surface 623 toward the mold 64. In short, the protrusion 62B protrudes in the die matching direction from the end surface 623. The protrusion 62B has a cylindrical shape. In other words, the protrusion 62B extends in the die matching direction with a substantially constant diameter. The protrusion 62B has a rounded tip end surface. The diameter of the protrusion 62B is greater than the diameter of the protrusion 62A.

A recess portion 641 that serves as a second recess portion is formed in the mold 64. The recess portion 641 is open on a die matching surface 642 with the mold 62 in the mold 64. In other words, the recess portion 641 is open toward the mold 62. In short, the recess portion 641 is open in the die matching direction.

The recess portion 641 has an end surface 643. The end surface 643 is at a position separated the most from the die matching surface 642. In short, the end surface 643 regulates the end of the recess portion 641 in the die matching direction.

In the recess portion 641, a protrusion 64A is disposed. The protrusion 64A protrudes from the end surface 643 toward the mold 62. In short, the protrusion 64A protrudes in the die matching direction from the end surface 643. The protrusion 64A has a cylindrical shape. The protrusion 64A has an outer circumferential surface 64A1, a step surface 64A2, and an outer circumferential surface 64A3.

The outer circumferential surface 64A1 is a cylindrical surface that extends straight in the die matching direction with a substantially constant diameter. The outer circumferential surface 64A3 is a cylindrical surface that extends straight in the die matching direction with a substantially constant diameter. The diameter of the outer circumferential surface 64A3 is greater than the diameter of the outer circumferential surface 64A1. The step surface 64A2 is an annular surface. The inner circumferential end of the step surface 64A2 is connected to the right end of the outer circumferential surface 64A1 (the end which is separated from the mold mating surface 642 in the die matching direction). The outer circumferential end of the step surface 64A2 is connected to the left end of the outer circumference surface 64A3 (the end closer to the die matching surface 642 in the die matching direction).

The protrusion 64A has a tip end surface 64A4. The end surface 64A4 has an annular shape.

In the end surface 64A4, a protrusion 64B is formed. The protrusion 64B protrudes from the tip end surface 64A4 toward the mold 62. In short, the protrusion 64B protrudes in the die matching direction from the tip end surface 64A4. The protrusion 64B has a cylindrical shape. In other words, the protrusion 64B extends in the die matching direction with a substantially constant diameter. The protrusion 64B has a rounded tip end surface. In a state where the mold 62 and the mold 64 are die-matched, the protrusion 64B is positioned coaxially to the protrusion 62B. The tip end surface of the protrusion 64B overlaps the tip end surface of the protrusion 62B.

The protrusion 64A is inserted into the cylindrical section 521 of the core bar 52. In this state, the right end (the other axial end) of the cylindrical section 521 is in contact with the stepped surface 64A2. In other words, an insertion amount of the cylindrical section 521 is regulated by the step surface 64A2.

In the mold 64, an accommodating recess portion 64C is formed. The accommodating recess portion 64C is formed at a position at which the protrusion 64A is formed. The accommodating recess portion 64C is open in a direction opposite to the direction in which the protrusion 64A protrudes. The tip end part of a hot runner nozzle 70 is accommodated in the accommodating recess portion 64C.

The accommodating recess portion 64C has a cylindrical inner circumferential surface 64C1 and a tapered cylindrical inner circumferential surface 64C2. The right end of the inner circumferential surface 64C2 (the end farthest from the die matching surface 642 in the die matching direction) is connected to the left end of the inner circumferential surface 64C1 (the end closest to the die matching surface 642 in the die matching direction). The inner circumferential surface 64C1 extends straight in the die matching direction with a substantially constant diameter. The right end of the inner circumferential surface 64C1 (the end separated from the die matching surface 642 in the die matching direction) regulates an opening end of the accommodating recess portion 64C. The diameter of the inner circumferential surface 64C2 is smaller at the end separated from the inner circumferential surface 64C1 than that at the end connected to the inner circumferential surface 64C1.

In the mold 64, a gate 64D is formed. The gate 64D has a cylindrical inner circumferential surface. In other words, the gate 64D extends straight in the die matching direction with a substantially constant diameter. The right end of the gate 64D (the end separated from the die matching surface 642) is connected to the accommodating recess portion 64C (specifically the small diameter end of the inner circumferential surface 64C2). The left end (the end closer to the die matching surface 642) of the gate 64D is open to the tip end surface 64A4 of the protrusion 64A.

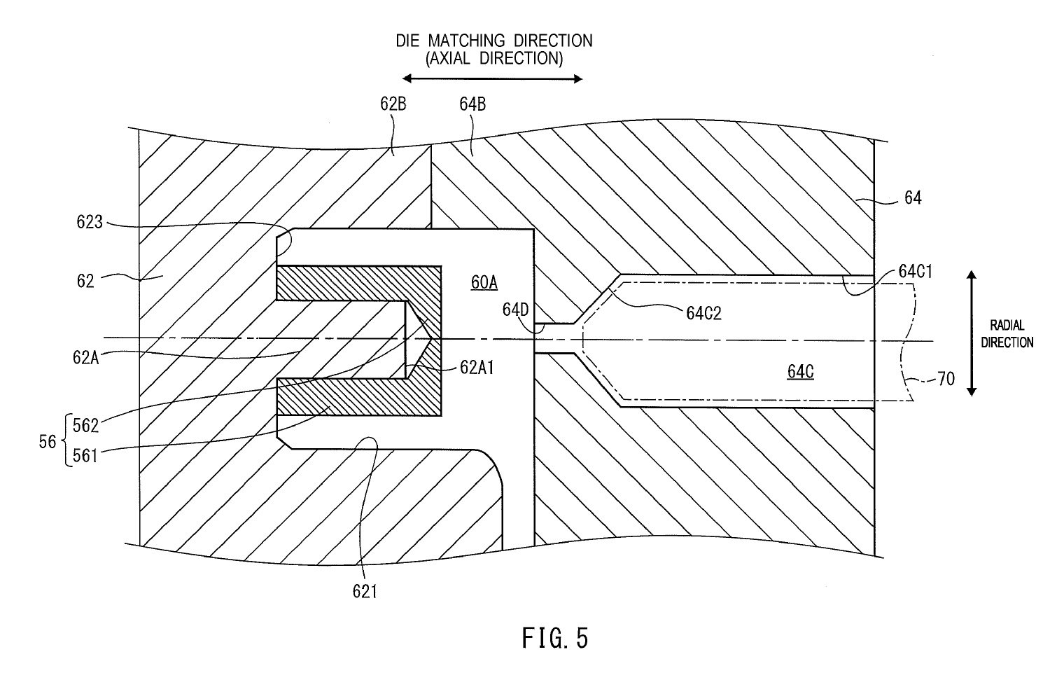

In a state where the mold 62 and the mold 64 are die-matched, as illustrated in FIG. 5, the center (the center in the radial direction) of the gate 64D matches the center (the center in the radial direction) of the protrusion 62A. In other words, the gate 64D is positioned coaxially to the protrusion 62A formed in the mold 62. In a state where the protrusion 62A is inserted in the cylindrical section 561, the center (the center in the radial direction) of the nut 56 matches the center (the center in the radial direction) of the gate 64D. In other words, the gate 64D is positioned coaxially to the nut 56. In short, when viewed from the die matching direction, the gate 64D is formed at a position that overlaps the stopper 562 of the nut 56. In other words, when viewed from the die matching direction, the gate 64 D is formed at a position that overlaps a region on the inside than the outer circumferential surface of the cylindrical section 561 of the nut 56.

Again, the description will refer to FIG. 4A. As illustrated in FIG. 4A, by die-matching the mold 62 and the mold 64, the cavity 60A is formed in the mold 60. In this state, as illustrated in FIG. 4B, a resin material is injected into the cavity 60A. The resin material is injected into the cavity 60A via the gate 64D. The injected resin material fills the inside of the cavity 60A.

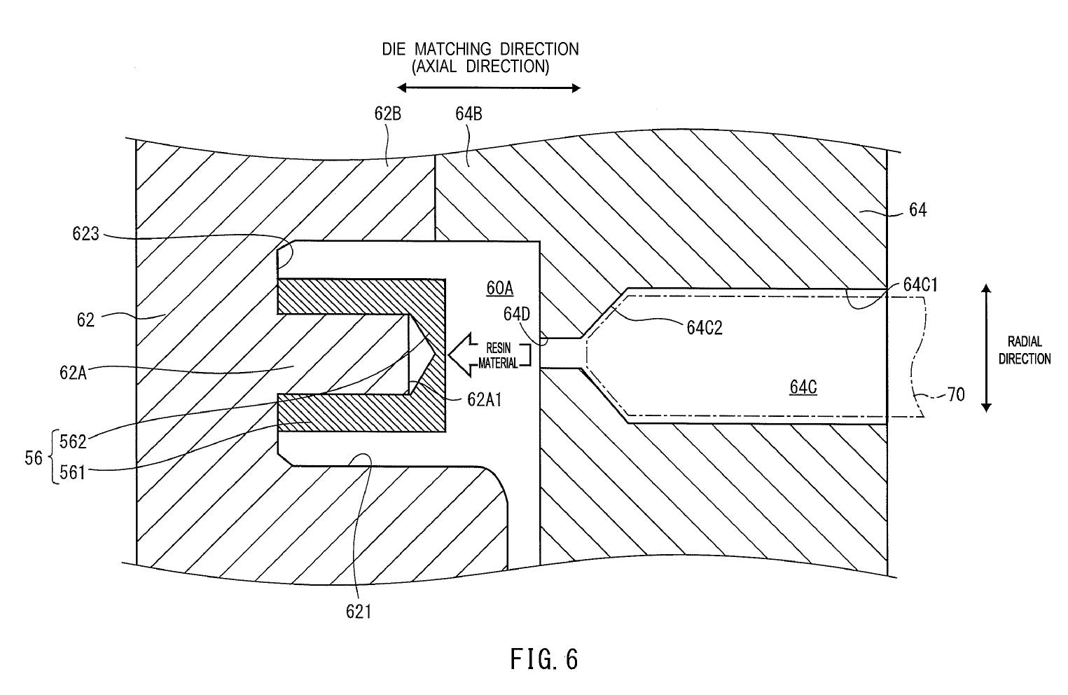

When being injected into the cavity 60A, the resin material strikes the stopper 562 of the nut 56 as illustrated in FIG. 6. The stopper 562 is pressed against the tip end surface of the protrusion 62A by a pressure when the resin material is injected. Therefore, it is possible to prevent the nut 56 from coming out of the protrusion 62A. In addition, the resin material which strikes the stopper 562 covers the axial end surface of the nut 56, then goes around radially to the outside of the nut 56, and covers the outer circumferential surface of the nut 56. In other words, the nut 56 can be prevented from moving in the radial direction with respect to the protrusion 62A. In this manner, by covering the axial end surface and the outer circumferential surface of the nut 56 with the resin material, the nut 56 can be positioned.

By solidifying the resin material injected into the cavity 60A, a cover 50 that serves as a molded product is obtained. The cover 50 is detached from the mold 60 as follows.

First, the mold 62 is retracted and the mold 62 is pulled away from the mold 64. At this time, the cover 50 moves together with the mold 62. Accordingly, as illustrated in FIG. 4C, the cover 50 can be detached from the mold 64. In addition, when a draft angle of the mold 62 and the mold 64 is appropriately set, and when the mold 62 is retracted, the cover 50 can be detached from the mold 64.

Next, the cover 50 is detached from the mold 62 by a plurality of pins 66 disposed in the mold 62. The pin 66 has a cylindrical shape. The pin 66 extends straight in the die matching direction with a circular cross section. The pin 66 is disposed in a hole 624 formed in the mold 62. The hole 624 has a cylindrical inner circumferential surface which extends in the die matching direction with a substantially constant diameter. The pin 66 is slidably disposed in the die matching direction. The end surface of the pin 66 is in contact with the end surface 541A of the covering portion 541 of the cover main body 54. The plurality of pins 66 are disposed at equivalent intervals in the circumferential direction. When viewed from the die matching direction, the pin 66 is disposed at a position that overlaps the flange portion 522 of the core bar 52.

When detaching the cover 50 from the mold 62, the plurality of pins 66 are moved in the die matching direction. Accordingly, a plurality of pins 66 are pressed against the end surface 541A of the covering portion 541 of the cover 50. As a result, the cover 50 is detached from the mold 62.

In addition, when the plurality of pins 66 are moved at the same time, the force which acts on the cover 50 becomes uniform in the circumferential direction. As a result, when detaching the cover 50 from the mold 62, the cover 50 becomes difficult to be deformed.

As illustrated in FIG. 1, the cover 50 is assembled to the hub unit 10 by inserting the cylindrical section 521 of the core bar 52 into the outer ring 12 of the hub unit 10. In this state, the sensor 40 for detecting the rotation of the inner shaft 14 is attached to the cover 50. Specifically, the sensor 40 is inserted into the insertion hole 543 formed in the cover 50. The attachment portion 40A provided in the sensor 40 overlaps the end surface of the attachment portion 542 and is fixed to the attachment portion 542 of the cover 50 by a bolt 42 inserted into the nut 56.

As illustrated in FIG. 3, in a state where the cover 50 is attached to the outer ring 12, the outer circumferential surface of the covering layer 544 of the cover 50 is in contact with the inner circumferential surface of the outer ring 12, and the end surface 541C of the covering portion 541 of the cover 50 is in contact with the end surface in the axial direction of the outer ring 12.

In the above-described production method, the cover 50 is detached from the mold 62 by pushing the end surface 541A of the covering portion 541 of the cover 50 with the plurality of pins 66. In other words, the plurality of pins 66 are not pressed against the end surface 541C which is in contact with the end surface in the axial direction of the outer ring 12, in the cover 50. Therefore, the recess formed by pressing the pin 66 is not present on the end surface 541C. As a result, it is possible to prevent foreign substances which have entered the recess from being caught between the covering portion 541 and the outer ring 12. Therefore, it is possible to ensure sealing properties between the cover portion 541 and the outer ring 12.

In the above-described production method, the plurality of pins 66 are disposed at equivalent intervals in the circumferential direction. Therefore, it is possible to make the force when pushing the cover 50 uniform in the circumferential direction. As a result, when detaching the cover 50 from the mold 62, the cover 50 becomes difficult to be deformed.

In the above-described production method, each of the plurality of pins 66 is disposed at a position that overlaps the flange portion 522 of the core bar 52 when viewed from the die matching direction. Therefore, the force when pressing the cover 50 can be applied to the core bar 52 (specifically, the flange portion 522). As a result, when detaching the cover 50 from the mold 62, the cover 50 becomes difficult to be deformed.

Although the embodiments of the present invention have been described in detail above, these are merely examples, and the present invention is not limited in any manner by the above-described embodiments.

For example, in the above-described embodiment, the nut 56 is pressed by the resin material injected into the cavity 60A, but the nut 56 may be pressed by a pin that can advance and retreat. In this case, the pin which can advance and retreat is disposed in the mold 64.

This application is based upon and claims the benefit of priority from Japanese Patent Application No. 2015-223007, filed Nov. 13, 2015, the entire contents of which are incorporated herein by reference.

### DESCRIPTION OF REFERENCE SIGN(S)

10: hub unit
12: outer ring
50: cover
52: core bar
521: cylindrical section
522: flange portion
56: nut
60: mold
60A: cavity
62: mold
62A: protrusion
621: recess portion
64: mold
64A: protrusion
641: recess portion
66: pin

1. A production method for a cover to be attached to an outer ring of a hub unit, comprising:
preparing a first mold comprising a first protrusion which protrudes into a first recess portion that forms a part of a cavity to be filled with a resin material;
preparing a second mold comprising a second protrusion which protrudes into a second recess portion that forms another part of the cavity;
supporting a nut by the first protrusion;
supporting a core bar comprising a cylindrical section to be inserted into the outer ring by the second protrusion;
forming the cavity by performing die matching with respect to the first mold and the second mold;
forming the cover comprising the nut and the core bar by injecting a resin material into the cavity;
detaching the cover from the second mold by moving the first mold in a direction away from the second mold; and
detaching the cover from the first mold by pushing out the cover in a die matching direction with a pin disposed in the first mold after detaching the cover from the second mold.

2. The production method for a cover according to claim 1,
wherein the core bar further comprises a flange which is formed at one axial end of the cylindrical section, and extends outward in a radial direction of the cylindrical section from the one axial end of the cylindrical section,
wherein the cover comprises a covering portion which covers the flange, and
wherein the cover is detached from the first mold by pressing the covering portion with the pin.

3. The production method for a cover according to claim 2,
wherein the cover is detached from the first mold by pressing a position in the covering portion which overlaps the flange with the pin when viewed from the die matching direction.

4. The production method for a cover according to claim 1,
wherein a plurality of the pins are disposed in the first mold.

5. The production method for a cover according to claim 4,
wherein the plurality of the pins are disposed at equivalent intervals in a circumferential direction of the cylindrical section.
